(19) United States
(12) Patent Application Publication
(10) Pub. No.: US 2020/0279309 A1
(43) Pub. Date: Sep. 3, 2020

(54) BLOCKCHAIN-BASED ELECTRONIC BILL CANCELLATION METHOD, APPARATUS, AND ELECTRONIC DEVICE

(71) Applicant: Alibaba Group Holding Limited, George Town (KY)

(72) Inventors: Zhenzhong Meng, Hangzhou (CN); Longsheng Qing, Hangzhou (CN); Ge Jin, Hangzhou (CN); Zhen Sun, Hangzhou (CN); Yu Chu, Hangzhou (CN); Xueqing Yang, Hangzhou (CN)

(73) Assignee: Alibaba Group Holding Limited, George Town (KY)

(21) Appl. No.: 16/783,098

(22) Filed: Feb. 5, 2020

Related U.S. Application Data
(63) Continuation of application No. PCT/CN2020/072139, filed on Jan. 15, 2020.

(30) Foreign Application Priority Data
Jul. 31, 2019 (CN) 201910703798.9

(51) Int. Cl. G06Q 30/04; G06Q 20/40

(52) U.S. Cl. CPC G06Q 30/04; G06Q 2220/12; G06Q 20/401

(57) ABSTRACT

One or more implementations of the present specification provide a blockchain-based electronic bill cancellation method, apparatus, and an electronic device. The blockchain stores electronic bills. The method includes, in response to detecting a cancellation transaction that is corresponding to a target electronic bill and that is broadcasted to the blockchain, determining whether the target electronic bill has been accounted; if the target electronic bill has not been accounted, updating the target electronic bill to a cancelled state; or if the target electronic bill has been accounted, broadcasting a reversed bill corresponding to the target electronic bill to the blockchain for storage.

### CROSS-REFERENCE TO RELATED APPLICATIONS

This application is a continuation of PCT Application No. PCT/CN2020/072139, filed on Jan. 15, 2020, which claims priority to Chinese Patent Application No. 201910703798.9, filed on Jul. 31, 2019, and each application is hereby incorporated by reference in its entirety.

### TECHNICAL FIELD

One or more implementations of the present specification relate to the field of blockchain technologies, and in particular, to a blockchain-based electronic bill cancellation method, apparatus, and an electronic device.

### BACKGROUND

Blockchain technology, also known as distributed ledger technology, is an emerging technology in which several computing devices participate in “record-keeping” and jointly maintain a complete distributed database. Since blockchain technology has the characteristics of decentralization, openness, and transparency, each computing device can participate in database records, and data can be quickly synchronized between computing devices, blockchain technology has been widely used in many fields.

### SUMMARY

The present specification provides a blockchain-based electronic bill cancellation method, where the method is applied to a node on the blockchain, the blockchain stores electronic bills, and the method includes: determining whether a target electronic bill has been accounted when a cancellation transaction corresponding to the target electronic bill and broadcasted to the blockchain is monitored; if the target electronic bill has not been accounted, updating the maintained target electronic bill to a cancelled state; or if the target electronic bill has been accounted, broadcasting a created reversed bill corresponding to the target electronic bill to the blockchain for storage.

Optionally, determining whether a target electronic bill has been accounted includes: determining whether the maintained target electronic bill is in an accounted state; if the target electronic bill is in the accounted state, determining that the target electronic bill has been accounted; or if the target electronic bill is not in the accounted state, determining that the target electronic bill has not been accounted.

Optionally, broadcasting a created reversed bill corresponding to the target electronic bill to the blockchain for storage includes: invoking a bill creation logic specified in a smart contract deployed on the blockchain, to create the reversed bill corresponding to the target electronic bill.

Optionally, the cancellation transaction corresponding to the target electronic bill and broadcasted to the blockchain is a refund transaction corresponding to the target electronic bill and broadcasted by a drawee of the target electronic bill to the blockchain; and the method further includes: instructing a drawer of the target electronic bill to perform refund processing on the target electronic bill after the created reversed bill corresponding to the target electronic bill is broadcasted to the blockchain for storage.

Optionally, the drawer of the target electronic bill subscribes to a bill state of the target electronic bill maintained by the node; and instructing a drawer of the target electronic bill to perform refund processing on the target electronic bill after the created reversed bill corresponding to the target electronic bill is broadcasted to the blockchain for storage includes: after the created reversed bill corresponding to the target electronic bill is broadcasted to the blockchain for storage, updating the maintained target electronic bill to a reversed bill-created state, and pushing the reversed bill-created state of the target electronic bill to the drawer, so as to trigger the drawer to perform refund processing on the target electronic bill.

Optionally, determining whether a target electronic bill has been accounted when a cancellation transaction corresponding to the target electronic bill and broadcasted to the blockchain is monitored includes: invoking, in response to the refund transaction, a refund verification logic specified in a smart contract deployed on the blockchain, to determine whether the target electronic bill satisfies refund criteria; and determining, in response to a monitored verification success event generated by the smart contract and corresponding to the target electronic bill, whether the target electronic bill has been accounted.

Optionally, the refund criteria include refund permission criteria, refund amount criteria, and refund period criteria.

Optionally, the cancellation transaction corresponding to the target electronic bill and broadcasted to the blockchain is a cancellation transaction corresponding to the target electronic bill and broadcasted by a drawer of the target electronic bill to the blockchain; and determining whether a target electronic bill has been accounted when a cancellation transaction corresponding to the target electronic bill and broadcasted to the blockchain is monitored includes: invoking, in response to the cancellation transaction, a cancellation verification logic specified in a smart contract deployed on the blockchain to determine whether the target electronic bill satisfies cancellation criteria; and determining, in response to a monitored verification success event generated by the smart contract and corresponding to the target electronic bill, whether the target electronic bill has been accounted.

Optionally, the cancellation criteria include cancellation permission criteria and cancellation period criteria.

The present specification further provides a blockchain-based electronic bill cancellation apparatus, where the apparatus is applied to a node on the blockchain, the blockchain stores electronic bills, and the apparatus includes: a determining module, configured to determine whether a target electronic bill has been accounted when a cancellation transaction corresponding to the target electronic bill and broadcasted to the blockchain is monitored; an update module, configured to: if the target electronic bill has not been accounted, update the maintained target electronic bill to a cancelled state; and a creation module, configured to: if the target electronic bill has been accounted, broadcast a created reversed bill corresponding to the target electronic bill to the blockchain for storage.

Optionally, the determining module is configured to: determine whether the maintained target electronic bill is in an accounted state; if the target electronic bill is in the accounted state, determine that the target electronic bill has been accounted; or if the target electronic bill is not in the accounted state, determine that the target electronic bill has not been accounted.

Optionally, the creation module is configured to: invoke a bill creation logic specified in a smart contract deployed on the blockchain, to create the reversed bill corresponding to the target electronic bill.

Optionally, the cancellation transaction corresponding to the target electronic bill and broadcasted to the blockchain is a refund transaction corresponding to the target electronic bill and broadcasted by a drawee of the target electronic bill to the blockchain; and the apparatus further includes: an instruction module, configured to instruct a drawer of the target electronic bill to perform refund processing on the target electronic bill after the created reversed bill corresponding to the target electronic bill is broadcasted to the blockchain for storage.

Optionally, the drawer of the target electronic bill subscribes to a bill state of the target electronic bill maintained by the node; and the instruction module is configured to: after the created reversed bill corresponding to the target electronic bill is broadcasted to the blockchain for storage, update the maintained target electronic bill to a reversed bill-created state, and push the reversed bill-created state of the target electronic bill to the drawer, so as to trigger the drawer to perform refund processing on the target electronic bill.

Optionally, the determining module is configured to: invoke, in response to the refund transaction, a refund verification logic specified in a smart contract deployed on the blockchain to determine whether the target electronic bill satisfies refund criteria; and determine, in response to a monitored verification success event generated by the smart contract and corresponding to the target electronic bill, whether the target electronic bill has been accounted.

Optionally, the refund criteria include refund permission criteria, refund amount criteria, and refund period criteria.

Optionally, the cancellation transaction corresponding to the target electronic bill and broadcasted to the blockchain is a cancellation transaction corresponding to the target electronic bill and broadcasted by a drawer of the target electronic bill to the blockchain; and

the determining module is configured to: invoke, in response to the cancellation transaction, a cancellation verification logic specified in a smart contract deployed on the blockchain to determine whether the target electronic bill satisfies cancellation criteria; and determine, in response to a monitored verification success event generated by the smart contract and corresponding to the target electronic bill, whether the target electronic bill has been accounted.

Optionally, the cancellation criteria include cancellation permission criteria and cancellation period criteria.

The present specification further provides an electronic device, including: a processor; and a memory, configured to store instructions that can be executed by the processor; where the processor implements steps of the method by running the executable instructions.

The present specification further provides a computer readable storage medium on which computer instructions are stored, and steps of the method are implemented when the instructions are executed by a processor.

In the previous technical solution, on one hand, when a cancellation transaction broadcasted to a blockchain and corresponding to an electronic bill that has not been accounted is monitored, the maintained electronic bill can be updated to a cancelled state. On the other hand, when a cancellation transaction broadcasted to a blockchain and corresponding to an electronic bill that has been accounted is monitored, a created reversed bill corresponding to the electronic bill can be broadcasted to the blockchain for storage. As such, the electronic bill stored in the blockchain can be cancelled.

### BRIEF DESCRIPTION OF DRAWINGS

FIG. 1 is a schematic diagram of organizing account state data of a blockchain into an MPT state tree, according to the present specification;

FIG. 2 is a schematic diagram illustrating node reusing in an MPT state tree, according to the present specification;

FIG. 3 is a schematic diagram illustrating a procedure for creating a smart contract, according to the present specification;

FIG. 4 is a schematic diagram illustrating a procedure for invoking a smart contract, according to the present specification;

FIG. 5 is a schematic diagram illustrating a procedure for creating and invoking a smart contract, according to the present specification;

FIG. 6 is a schematic diagram illustrating a blockchain-based electronic bill cancellation system, according to an example implementation of the present specification;

FIG. 7 is a schematic diagram illustrating a bill state update procedure of an electronic bill, according to an example implementation of the present specification;

FIG. 8 is a flowchart illustrating a blockchain-based electronic bill cancellation method, according to an example implementation of the present specification;

FIG. 9 is a schematic structural diagram illustrating an electronic device, according to an example implementation of the present specification;

FIG. 10 is a block diagram illustrating a blockchain-based electronic bill cancellation apparatus, according to an example implementation of the present specification.

### DESCRIPTION OF IMPLEMENTATIONS

Example implementations are described in detail here, and examples of the example implementations are presented in the accompanying drawings. When the following description relates to the accompanying drawings, unless specified otherwise, same numbers in different accompanying drawings represent same or similar elements. Example implementations described in the following do not represent all implementations consistent with the present specification. On the contrary, the implementations are only examples of apparatus and methods that are described in the appended claims in detail and consistent with some aspects of the present specification.

It is worthwhile to note that, in other implementations, steps of a corresponding method are not necessarily performed according to a sequence shown and described in the present specification. In some other implementations, the method can include more or less steps than those described in the present specification. In addition, a single step described in the present specification can be broken down into multiple steps in other implementations for description. However, the multiple steps described in the present specification can also be combined into a single step for description in other implementations.

Blockchains can generally be classified into three types: public blockchains, private blockchains, and consortium blockchains. In addition, there are several types of combinations, such as private blockchain+consortium blockchain and consortium blockchain+public blockchain.

The public blockchain has the highest degree of de-centralization. The public blockchain is represented by Bitcoin and Ethereum. Participants (also referred to as blockchain nodes) who join the public blockchain can read on-chain data records, participate in transactions, and compete for accounting rights of new blocks. In addition, each node can freely join or exit a network and perform related operations.

On the contrary, a write right of the private blockchain network is controlled by a certain organization or institution, and a data reading right is specified by the organization. In short, the private blockchain can be a weak centralization system, and participating nodes are strictly limited and rare. This type of blockchain is more suitable for internal use within a specific organization.

The consortium blockchain is a blockchain balanced between the public blockchain and the private blockchain, and can be “partially decentralized”. Each node in the consortium blockchain usually has a corresponding entity institution or organization. Nodes join the network through authorization and form interest-related consortiums to jointly maintain blockchain operation.

Based on the basic characteristics of the blockchain, the blockchain usually consists of several blocks. Timestamps corresponding to creation moments of these blocks are separately recorded in these blocks, and all the blocks strictly form a time-ordered data chain based on the timestamps recorded in the blocks.

For real data generated in the physical world, the data can be formed into a standard transaction format supported by the blockchain, and then broadcasted to the blockchain. Nodes in the blockchain perform consensus processing on the received transaction. After the consensus is reached, a node serving as a bookkeeping node in the blockchain seals the transaction into a block and persistently stores the transaction in the blockchain.

Consensus algorithms supported in the blockchain can include: a first-type consensus algorithm where a node needs to compete for the bookkeeping right in each round of bookkeeping, such as Proof of Work (POW), Proof of Stake (POS), and Delegated Proof of Stake (DPOS); a second-type consensus algorithm where a bookkeeping node is elected in advance for each round of bookkeeping (there is no need to compete for the bookkeeping right), such as a Practical Byzantine Fault Tolerance (PBFT).

In a blockchain network using the first-type consensus algorithm, all nodes that compete for the bookkeeping right can execute a transaction after receiving the transaction. One of the nodes that compete for the bookkeeping right can prevail in a current round and become the bookkeeping node. The bookkeeping node can seal a received transaction with other transactions to generate a latest block, and send the generated latest block or a block header of the latest block to other nodes for reaching consensus.

In a blockchain network using the second-type consensus algorithm, a node having the bookkeeping right has been agreed upon before the current round of bookkeeping. Therefore, after receiving a transaction, a node can send the transaction to the bookkeeping node if the node is not the bookkeeping node of the current round. The bookkeeping node in the current round can execute the transaction when or before packaging the transaction with other transactions to generate a latest block. After generating the latest block, the bookkeeping node can send the latest block or a block header of the latest block to other nodes for reaching consensus.

As described above, regardless of which consensus algorithm is used in the blockchain, the bookkeeping node in the current round can seal the received transaction to generate the latest block, and send the generated latest block or the block header of the latest block to other nodes for consensus verification. After receiving the latest block or the block header of the latest block, if the other nodes verify that the latest block is correct, the other nodes can append the latest block to the end of the original blockchain, so as to complete a bookkeeping process of the blockchain. In the process of verifying a new block or block header from the bookkeeping node, the other nodes can also execute a transaction included in the block.

In the blockchain field, an important concept is account. Taking Ethereum as an example, Ethereum usually divides accounts into external accounts and contract accounts. The external account is an account directly controlled by a user, and is also called a user account. The contract account is created by the user through an external account and contains a contract code (that is, a smart contract). Certainly, for some blockchain projects (for example, Ant Blockchain) derived from an Ethereum-based architecture, account types supported by the blockchain can be further extended, and are not limited in the present specification.

The state of an account in the blockchain is usually maintained through a structural body. When a transaction in a block is executed, the state of an account associated with the transaction in the blockchain usually changes.

Taking Ethereum as an example, a structural body of an account usually includes fields such as Balance, Nonce, Code, and Storage, where: the Balance field is used to maintain the current account balance; the Nonce field is used to maintain the number of transactions of the account, and is a counter used to ensure that each transaction can be processed only once, effectively avoiding replay attacks; the Code field is used to maintain the contract code of the account; in practice, the Code field usually maintains only the hash value of the contract code; therefore, the Code field is also commonly referred to as a Codehash field; and the Storage field is used to maintain the storage content of the account (the default field value is null). For the contract account, an independent storage space is usually allocated to store the content of the contract account. The independent storage space is commonly referred to as the account storage of the contract account. The storage content of the contract account usually constructs a data structure of a Merkle Patricia Trie (MPT) tree and stored in the above-mentioned independent storage space. An MPT tree constructed based on the storage content of the contract account is usually referred to as a Storage tree. The Storage field usually maintains only the root node of the Storage tree. Therefore, the Storage field is also commonly referred to as a StorageRoot field.

For an external account, field values of both the Code field and the Storage field shown above are null.

In most blockchain projects, the Merkle tree is usually used, or data is stored and maintained based on a data structure of the Merkle tree. Taking Ethereum as an example, the MPT tree (a variant of the Merkle tree) is used in Ethereum as a data organization form to organize and manage important data such as account state and transaction information.

For data to be stored and maintained in the blockchain, Ethereum uses three MPT trees: MPT state tree, MPT transaction tree, and MPT receipt tree. In addition to the previous three MPT trees, there is actually a storage tree constructed based on storage content of a contract account.

The MPT state tree is an MPT tree organized by account state data of all accounts in the blockchain. The MPT transaction tree is an MPT tree organized by transaction data in the blockchain. The MPT receipt tree is an MPT tree organized by a transaction receipt corresponding to each transaction generated after the transaction in the block is executed. Hash values of root nodes of the MPT state tree, the MPT transaction tree, and the MPT receipt tree are finally added to block headers of corresponding blocks.

Both the MPT transaction tree and the MPT receipt tree are corresponding to blocks, that is, each block has its own MPT transaction tree and MPT receipt tree. The MPT state tree is a global MPT tree, and does not correspond to a specific block, but covers account state data of all accounts in the blockchain.

Organized MPT transaction tree, MPT receipt tree, and MPT state tree are finally stored in a Key-Value type database (for example, LevelDB) that uses a multi-level data storage structure.

The previous database that uses the multi-level data storage structure can be divided into n-level data storage. For example, data storage at all levels can be successively set to L0, L1, L2, L3, . . . , and L (n-1). For data storage at all levels in the previous database, a smaller level number usually corresponds to a higher level. For example, L0 stores data of several latest blocks, L1 stores data of several secondary-latest blocks, and so on.

Reading and writing performance of a storage medium corresponding to each level of data storage can usually be different. For example, reading/writing performance of a storage medium corresponding to data storage of a higher level (that is, a smaller level number) can be higher than reading/writing performance of a storage medium corresponding to data storage of a lower level. In practice, a storage medium with a relatively high storage cost and high storage performance can be used for high-level data storage, and a storage medium with a low unit cost and a relatively large capacity can be used for low-level data storage.

In practice, as a block number of the blockchain increases (also referred to as a block height), data stored in a database includes many historical data. In addition, data in a block with a smaller block number is more aged and is less important. Therefore, to reduce overall storage costs, data of different block heights can usually be “treated differently”. For example, data in a block with a smaller block number is stored in a storage medium with a lower cost, and data in a block with a larger block number is stored in a storage medium with a higher cost.

It is worthwhile to note that, each time a latest block is generated in the blockchain, after a transaction in the latest block is executed, an account state of a related account (which can be an external account or a contract account) of the executed transaction in the blockchain usually changes accordingly.

For example, when a “transfer transaction” in a block is executed, balances of transfer-out and transfer-in accounts associated with the “transfer transaction” (that is, field values of the Balance fields of these accounts) usually change accordingly.

After the transaction in the latest block generated in the blockchain is executed, because an account state in the current blockchain changes, a node needs to construct an MPT state tree based on current account state data of all accounts in the blockchain, so as to maintain the latest states of all accounts in the blockchain.

That is, each time a latest block is generated in the blockchain, after a transaction in the latest block is executed, an account state in the blockchain changes, and the node needs to reconstruct an MPT state tree based on the latest account state data of all accounts in the blockchain. In other words, each block in the blockchain has a corresponding MPT state tree. The MPT state tree maintains the latest account states of all accounts in the blockchain after a transaction in the block is executed.

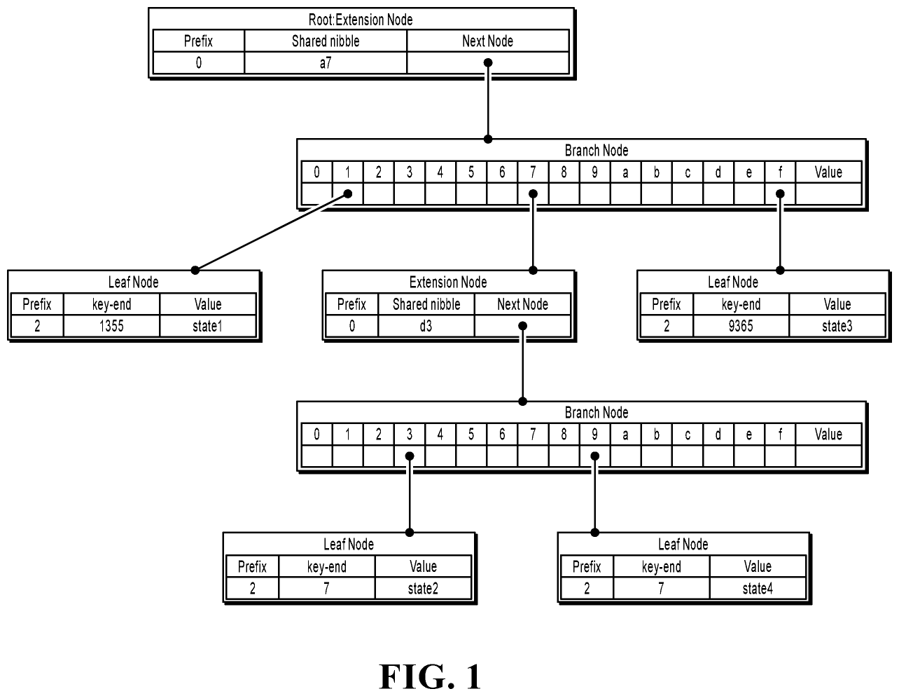

Referring to FIG. 1, FIG. 1 is a schematic diagram of organizing account state data of a blockchain into an MPT state tree, according to the present specification.

The MPT tree is an improved Merkle tree variant and incorporates advantages of the Merkle tree and the Trie dictionary tree (also referred to as a prefix tree).

The MPT tree usually includes three types of data nodes: leaf node, extension node, and branch node.

The leaf node is a key value pair represented as [key, value], where key is a special hexadecimal code character, and value is state data (that is, the structural body shown above) of an account address corresponding to the leaf node. The extension node is also a key value pair represented as [key, value], where key is also a special hexadecimal code character, but value is a hash value (hash pointer) of another node, that is, can be linked to another node by using a hash pointer.

The branch node contains 17 elements, the first 16 elements correspond to 16 possible hexadecimal characters in the key, and one character corresponds to one nibble (half byte). If a [key, value] terminates at this branch node, the branch node can act as a leaf node, and the last element represents a value of the leaf node. Conversely, the last element of the branch node can be null.

Characters on a search path from a root node to a leaf node on an MPT tree form a complete account address. Therefore, a branch node can be a termination node of the search path or can be an intermediate node of the search path.

Assume that account state data that needs to be organized into an MPT state tree is shown in Table 1:

TABLE 1

| Account address (Key) | | | | | | | Account state (Value) |
|---|---|---|---|---|---|---|---|
| a | 7 | 1 | 1 | 3 | 5 | 5 | state1 |
| a | 7 | 7 | d | 3 | 3 | 7 | state2 |
| a | 7 | f | 9 | 3 | 6 | 5 | state3 |
| a | 7 | 7 | d | 3 | 9 | 7 | state4 |

In Table 1, the account address is a string of several hexadecimal characters. The account state is a structural body formed by fields such as Balance, Nonce, Code, and Storage.

Finally, the MPT state tree is organized based on the account state data in Table 1. Referring to FIG. 1, the MPT state tree includes four leaf nodes, two branch nodes, and two extension nodes.

In FIG. 1, the prefix field is commonly owned by an extension node and a leaf node. Different field values of the prefix field can be used to indicate different node types.

For example, value 0 of the prefix field indicates an extension node that includes an even number of nibbles. As mentioned above, nibble represents a half byte, and consists of four binary bits. One nibble can correspond to one character that forms an account address. Value 1 of the prefix field indicates an extension node that includes an odd number of nibbles. Value 2 of the prefix field indicates a leaf node that includes an even number of nibbles. Value 3 of the prefix field indicates a leaf node that includes an odd number of nibbles.

However, the branch node does not have the prefix field because the branch node is a prefix node parallel to a single nibble.

The Shared nibble field in the extension node corresponds to a key value of a key value pair included in the extension node and indicates a common character prefix between account addresses. For example, all account addresses in the previous table have a common character prefix a7. The Next Node field is filled with a hash value (hash pointer) of a next node.

Hexadecimal characters 0 to f fields in a branch node correspond to a key value of a key value pair included in the branch node. If the branch node is an intermediate node whose account address is on a search path in an MPT tree, the Value field of the branch node can be null. The 0 to f fields are used to populate the hash value of the next node.

Key-end in a leaf node corresponds to a key value of a key value pair included in the leaf node, and represents last several characters of an account address. Key values of all nodes on a search path starting from a root node to a leaf node construct a complete account address. The Value field of the leaf node populates account state data corresponding to the account address. For example, a structural body including the previous Balance, Nonce, Code, and Storage fields can be filled in the Value field of the leaf node after being encoded.

Further, the node in the MPT state tree shown in FIG. 1 is finally stored in a database in the form of Key-Value pair.

When the node in the MPT state tree is stored in a database, Key in a key value pair of the node in the MPT state tree is a hash value of data content included in the node. Value in the key value pair of the node in the MPT state tree is data content included in the node.

That is, when the node in the MPT state tree is stored in the database, a hash value of data content included in the node can be calculated (that is, hash calculation is performed on the node as a whole), the calculated hash value is used as a key, and the data content included in the node is used as a value to generate a Key-Value pair. Then, the generated Key-Value pair is stored in the database.

The node in the MPT state tree is stored by using the hash value of the data content included in the node as Key and the data content included in the node as Value. Therefore, when the node in the MPT state tree needs to be queried, content addressing can be generally performed by using the hash value of the data content included in the node as Key. In terms of “content addressing”, for some nodes with “duplicate content”, “reusing” is usually performed to save storage space of data storage.

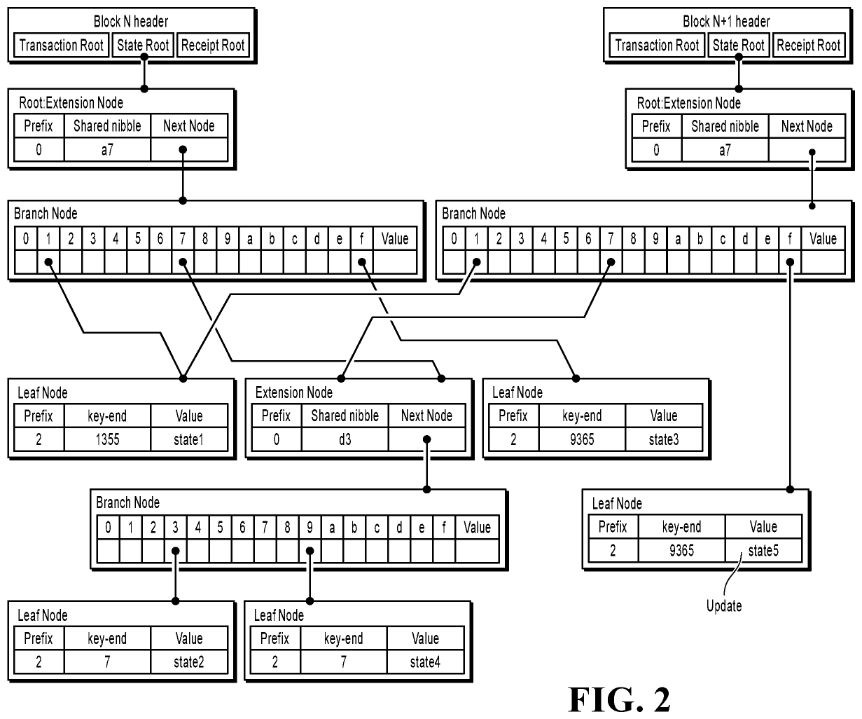

As shown in FIG. 2, FIG. 2 is a schematic diagram illustrating node reusing in an MPT state tree, according to the present specification. It is worthwhile to note that, in practice, after a transaction in a latest block generated by the blockchain is executed, account states of only some accounts can be changed. Therefore, when an MPT state tree is constructed, a complete MPT state tree does not need to be reconstructed based on current state data of all accounts in the blockchain, and only nodes corresponding to some accounts whose account states change need to be updated based on an MPT state tree corresponding to a previous block of the latest block. For nodes corresponding to accounts whose account states do not change on the MPT state tree, because no data update occurs on these nodes, corresponding nodes in the MPT state tree corresponding to the previous block of the latest block can be directly reused.

As shown in FIG. 2, assume that the account state data in Table 1 is the latest account states of all accounts in the blockchain after transaction execution in Block N is completed. The MPT state tree organized based on the account state data in Table 1 is still shown in FIG. 1.

Assume that after transaction execution in Block N+1 is completed, an account state at account address “a7f9365” in Table 1 is updated from “state3” to “state5”. In such case, when Block N+1 updates the MPT state tree, it is not necessary to reconstruct an MPT state tree based on current state data of all accounts in the blockchain after transaction execution in Block N+1 is completed.

In such case, only Value in a leaf node whose “key-end” is “9365” in the MPT state tree (that is, the MPT state tree shown in FIG. 1) corresponding to Block N can be updated from “state3” to “state5”, and hash pointers of all nodes on the path from the root node to the leaf node are to be updated accordingly.

That is, when the leaf node in the MPT state tree is updated, because the hash value of the entire leaf node is updated, the hash pointers of all nodes on the path from the root node to the leaf node are also updated accordingly.

For example, refer back to FIG. 2. In addition to the value in the leaf node whose “key-end” is “9365”, a hash pointer that is filled in the f field of a previous branch node of the leaf node and that points to the leaf node needs to be updated. Further, tracing back to the root node can further be performed, and a hash pointer that is filled in the “Next Node” field of a previous root node (Root Extension Node) of the branch node and that points to the branch node can be further updated.

Except the nodes that are updated above, for all nodes that are not updated, corresponding nodes in the MPT state tree of Block N can be directly reused.

The MPT tree corresponding to the Block N finally needs to be reserved as historical data. Therefore, when the MPT state tree is updated in Block N+1, the updated nodes are not directly modified and updated on the basis of the original nodes in the MPT state tree corresponding to Block N, but are recreated on an MPT tree corresponding to Block N+1. That is, in the MPT state tree corresponding to Block N+1, only a small number of nodes that are updated need to be created. For other nodes that are not updated, corresponding nodes in the MPT state tree corresponding to Block N can be directly reused.

For example, as shown in FIG. 2, in the MPT state tree corresponding to Block N+1, actually only one extension node serving as a root node, one branch node, and one leaf node need to be recreated. For nodes that are not updated, hash pointers pointing to the corresponding nodes in the MPT state tree corresponding to Block N can be added to these recreated nodes in the MPT state tree to complete “reusing” of the nodes. Nodes before the update in the MPT state tree corresponding to Block N are saved as historical account state data. For example, as shown in FIG. 2, the leaf node whose “key-end” is “9365” and value is “state3” will be saved as historical data.

In the previous example, a content update occurs on a small number of nodes in the MPT state tree of Block N+1, so most nodes of the previous block Block N can be “reused”. In practice, new nodes can be added to the MPT state tree of Block N+1 compared with that of the previous block Block N. In such case, although the newly added nodes cannot be directly “reused” from the MPT tree of the previous block Block N, but can be “reused” from an MPT state tree of a much earlier block.

For example, the nodes added to the MPT state tree of Block N+1 do not appear on the MPT state tree of Block N, but can appear on an MPT state tree of a much earlier block. For example, the nodes appear in the MPT state tree of Block N−1. Therefore, for the nodes added to the MPT state tree of Block N+1, corresponding nodes in the MPT state tree of Block N−1 can be directly reused.

In practice, the smart contract function can be provided for public, private, and consortium blockchains. The smart contract on the blockchain is a contract that can be triggered by a transaction on the blockchain. The smart contract is defined in the form of codes.

Taking Ethereum as an example, users can create and invoke some complex logics in the Ethereum network. An Ethereum virtual machine (EVM) is the core of Ethereum, which is a programmable blockchain, and each Ethereum node can run the EVM. The EVM is a Turing-complete virtual machine, through which various complex logics can be implemented. The user broadcasts and invokes the smart contract actually on the EVM in the Ethereum. In fact, the EVM directly runs virtual machine codes (virtual machine bytecode, “bytecode” for short), so the smart contract deployed on the blockchain can be bytecodes.

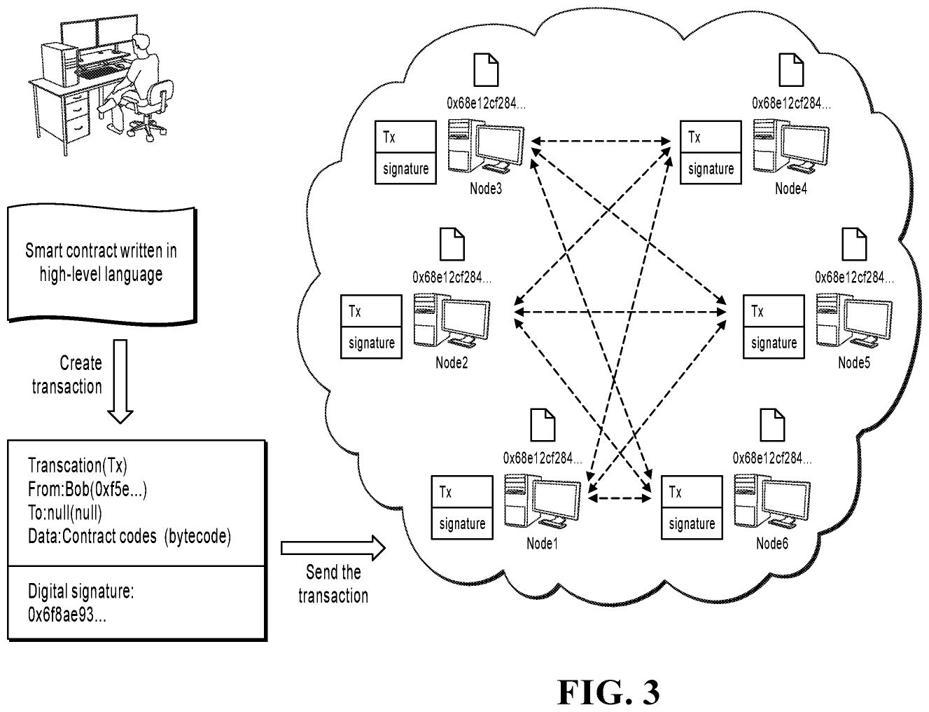

As shown in FIG. 3, after Bob sends a transaction containing information about creating a smart contract to the Ethereum network, each node can execute the transaction in the EVM. The From field of the transaction in FIG. 1 is used to record an address of an account that initiates the creating of the smart contract. Contract codes stored in a field value of the Data field of the transaction can be bytecodes, and a field value of the To field of the transaction is a null account. After a consensus is reached between nodes based on a consensus mechanism, the smart contract is successfully created. Subsequently, a user can invoke the smart contract.

After a smart contract is created, a contract account corresponding to the smart contract appears on the blockchain and has a specific address. For example, “0x68e12cf284 . . . ” on each node in FIG. 1 represents the address of the created contract account. A contract code and account storage are stored in the account storage of the contract account. The behavior of the smart contract is controlled by the contract code, and the account storage of the smart contract keeps the contract status. In other words, the smart contract causes a virtual account including the contract codes and account storage to be generated on the blockchain.

As mentioned above, the Data field of the transaction containing information about creating a smart contract can store the bytecodes of the smart contract. The bytecode consists of a series of bytes. Each byte can identify one operation. Based on development efficiency, readability, etc., developers may not write bytecodes directly, but choose high-level languages to write smart contract codes. For example, the high-level languages can be Solidity, Serpent, LLL, etc. For smart contract codes compiled in high-level languages, bytecodes that can be deployed on the blockchain can be generated through compiling by a compiler.

The Solidity language is used as an example. Contract codes compiled by using the Solidity language are similar to the Class in an object-oriented programming language. Multiple members can be specified in a contract, including a status variable, a function, a function modifier, an event, etc. The status variable is a value that is permanently stored in the account storage field of the smart contract and is used to store the status of the contract.

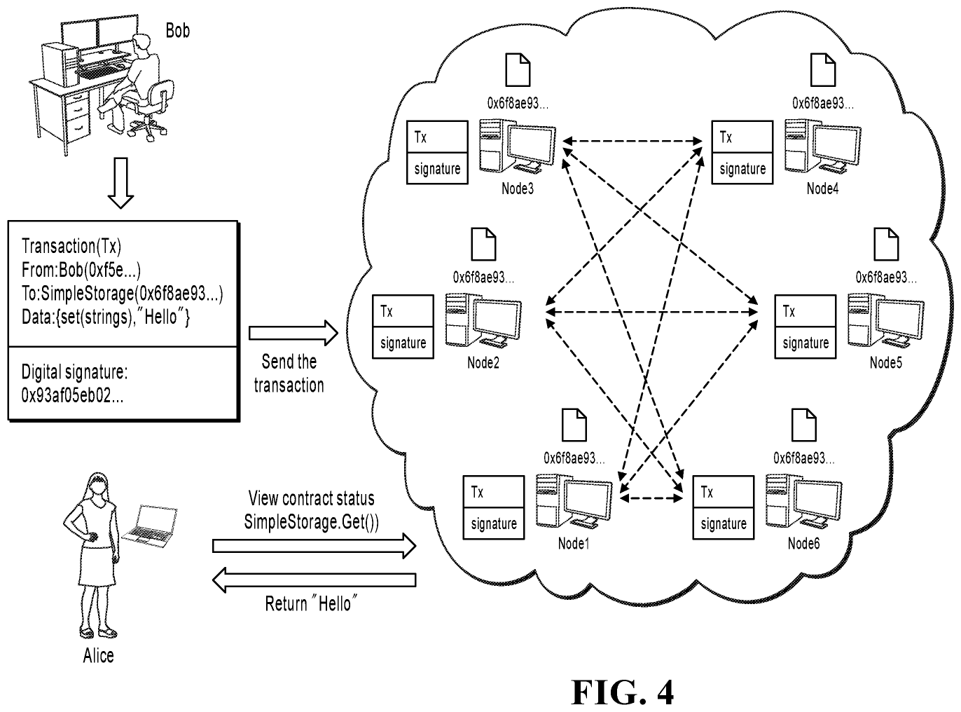

As shown in FIG. 4, Ethereum is still used as an example. After Bob sends a transaction containing information about invoking a smart contract to the Ethereum network, each node can execute the transaction in the EVM. In FIG. 4, the From field of the transaction is used to record an address of an account that initiates the invoking of the smart contract, the To field is used to record an address of the invoked smart contract, and the Data field of the transaction is used to record a method and a parameter for invoking the smart contract. After the smart contract is invoked, the account status of the contract account can change. Subsequently, a certain client can view the account status of the contract account by using an accessed blockchain node (for example, node 1 in FIG. 4).

The smart contract can be executed independently on each node in the blockchain network in a specified method, and all execution records and data are stored in the blockchain. Therefore, after such a transaction is executed, transaction vouchers that cannot be tampered with and will not be lost are stored in the blockchain.

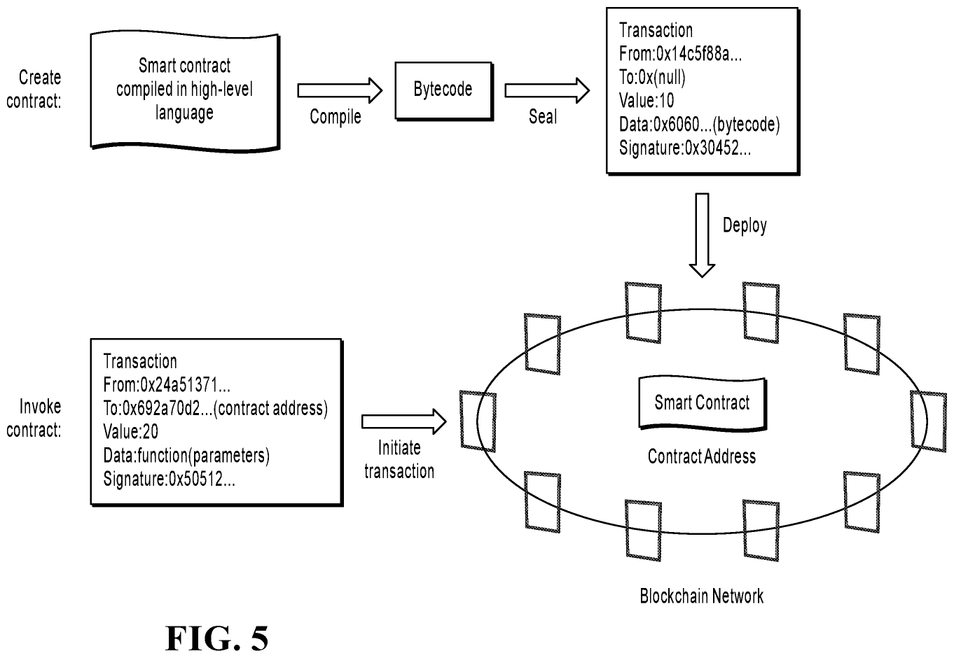

A schematic diagram of creating a smart contract and invoking a smart contract is shown in FIG. 5. Creating a smart contract in Ethereum requires the following processes: compiling the smart contract, changing the smart contract into bytecodes, and deploying the bytecodes to the blockchain. Invoking a smart contract in Ethereum means initiating a transaction pointing to a smart contract address. An EVM of each node can separately execute the transaction, and smart contract codes are distributed on a virtual machine of each node in the Ethereum network.

A conventional blockchain project represented by Ethereum usually supports the conversion of a real-world currency into a virtual token that can be circulated on the blockchain in order to realize “value transfer” on the blockchain.

In the blockchain field, for some blockchain projects (for example, Ant Blockchain) derived from an Ethereum-based architecture, a function of converting a real-world currency into a virtual token that can be circulated on the blockchain is usually not supported. Instead, in these blockchain projects, some non-monetary attribute physical assets in the real world can be converted into virtual assets that can be circulated on the blockchain.

It is worthwhile to note that converting the non-monetary attribute physical assets in the real world into the virtual assets on the blockchain generally refers to a process in which the physical assets are “anchored” with the virtual assets on the blockchain, and used as value support of these virtual assets, so as to generate, on the blockchain, the virtual assets that match the value of the physical assets and that can be circulated between blockchain accounts on the blockchain.

During implementation, account types supported by the blockchain can be extended. Based on the account types supported by the blockchain, an asset account (also referred to as an asset object) can be extended. For example, an asset account can be extended on the basis of the external account and the contract account supported by Ethereum. The extended asset account is a virtual asset that can use the real-word non-monetary attribute physical asset as the value support and that can be circulated between blockchain accounts.

For a user accessing such a blockchain, in addition to creating a user account and a smart contract on the blockchain, the user can create a virtual asset that matches the value of a real-world non-monetary attribute physical asset to circulate on the blockchain.

For example, the user can convert non-monetary attribute physical assets such as real estate, stocks, loan contracts, bills, and accounts receivable into value-matched virtual assets to circulate on the blockchain.

An account state of the previous asset account can also be maintained by using a structural body. Content included in the structural body of the asset account can be the same as that in the Ethereum, or can be designed based on an actual requirement.

In an implementation, for example, the content included in the structural body of the asset account is the same as that in Ethereum. The structural body of the asset account can also include fields such as Balance, Nonce, Code, and Storage that are described above.

It is worthwhile to note that in Ethereum, the Balance field is usually used to maintain a current account balance. However, for a blockchain project derived from an Ethereum-based architecture, because the blockchain project cannot support converting a real-world currency into a virtual token that can be circulated on the blockchain, in such a blockchain, the meaning of the Balance field can be extended and the Balance field does not represent the “balance” of an account, but is used to maintain address information of an asset account corresponding to a “virtual asset” held in the account. In practice, the Balance field can maintain address information of asset accounts corresponding to multiple “virtual assets”.

In such case, after address information of an asset account corresponding to a “virtual asset” to be held is added to the Balance field, the previous external account, contract account, and asset account can all hold the virtual asset. That is, in addition to the external account and the contract account, the asset account itself can hold virtual assets.

For the asset account, field values of the Nonce and Code fields can be null (or cannot be null). The field value of the Storage field can no longer be null. The Storage field can be used to maintain the asset state of the “virtual asset” corresponding to the asset account. A specific method of maintaining the asset state of the “virtual asset” corresponding to the asset account in the Storage field can be flexibly designed based on a requirement, and details are omitted.

In a blockchain project derived from an Ethereum-based architecture, the user can create a virtual asset on the blockchain that matches the value of a real-world non-monetary attribute physical asset through the following implementations:

In one implementation, the transaction types supported by the blockchain can be extended to obtain a transaction for creating a virtual asset. For example, transactions supported by Ethereum usually include a common transfer transaction, a transaction for creating a smart contract, and a transaction for invoking a smart contract. Based on the previous three types of transactions, a transaction for creating a virtual asset can be extended.

In such case, a user can broadcast a transaction for creating a virtual asset to a blockchain network via a client, and a node on the blockchain executes the transaction in a local EVM to create a virtual asset for the user. After nodes reach consensus based on a consensus mechanism, the virtual asset is successfully created, and an asset account corresponding to the virtual asset appears in the blockchain and has a specific address.

In another implementation, a smart contract for creating a virtual asset can also be deployed on the blockchain, and a process of deploying the smart contract for creating a virtual asset is not described again.

In such case, a user can broadcast a transaction for invoking the smart contract to a blockchain network via a client, and a node on the blockchain executes the transaction in a local EVM and runs a contract code related to the smart contract in the EVM to create a virtual asset for the user. After nodes reach consensus based on a consensus mechanism, the virtual asset is successfully created, and an asset account corresponding to the virtual asset appears in the blockchain and has a specific address.

Certainly, for some blockchain projects derived from an Ethereum-based architecture, if the blockchain projects also support the function of converting a real-world currency into a virtual token that can be circulated on the blockchain, some real-world non-monetary attribute physical assets can still be converted into virtual tokens that can be circulated on the blockchain. Details are omitted in the present specification.

In an inter-blockchain scenario, multiple blockchains can be interconnected by using inter-blockchain relays.

The inter-blockchain relay can separately interconnect with multiple blockchains by using bridging interfaces, and implement inter-blockchain data synchronization between the multiple blockchains based on an implemented data transport logic.

An inter-blockchain technology used to implement the previous inter-blockchain relay is not limited in the present specification. For example, in practice, multiple blockchains can be connected by using an inter-blockchain mechanism such as a side chain technology or a notary technology.

After multiple blockchains are interconnected by using inter-blockchain relays, data on other blockchains can be read and authenticated between the blockchains, or smart contracts deployed on other blockchains can be invoked by using inter-blockchain relays.

In addition to using data stored in the blockchain, the smart contract deployed on the blockchain can also use the Oracle machine to reference data on a data entity off the chain, so as to implement data exchange between the smart contract and the real-world data entity. The off-chain data entity can include a centralized server or data center deployed off the chain, etc.

Different from inter-blockchain relays, the Oracle machine does not synchronize data on one blockchain to another blockchain, but synchronizes data on an off-chain data entity to the blockchain.

That is, the inter-blockchain relay is used to connect two blockchains, and the Oracle machine is used to connect a blockchain with an off-chain data entity to implement data exchange between the blockchain and the real world.

The present specification is intended to provide a technical solution for cancelling electronic bills stored in a blockchain.

During specific implementation, a node on the blockchain can first determine whether a target electronic bill has been accounted when monitoring a cancellation transaction corresponding to the target electronic bill and broadcasted to the blockchain.

For example, the node on the blockchain can locally maintain a bill state of each electronic bill stored in the blockchain. When determining that the maintained target electronic bill is in an accounted state, the node on the blockchain can determine that the target electronic bill has been accounted.

If the target electronic bill has not been accounted, the node on the blockchain can directly update the maintained target electronic bill to a cancelled state, so as to implement cancellation processing on the target electronic bill.

If the target electronic bill has been accounted, the node on the blockchain can broadcast a created reversed bill corresponding to the target electronic bill to the blockchain for storage, so as to implement cancellation processing on the target electronic bill.

The node on the blockchain can locally create a reversed bill corresponding to the target electronic bill, and broadcast the reversed bill to the blockchain for storage. Or the node on the blockchain can invoke a bill creation logic specified in a smart contract deployed on the blockchain to directly create the reversed bill corresponding to the target electronic bill in the blockchain.

In practice, after broadcasting the reversed bill to the blockchain for storage, the node on the blockchain can update the maintained target electronic bill to a reversed bill-created state, so as to avoid a subsequent misoperation on the electronic bill.

In the previous technical solution, on one hand, when a cancellation transaction broadcasted to a blockchain and corresponding to an electronic bill that has not been accounted is monitored, the maintained electronic bill can be updated to a cancelled state. On the other hand, when a cancellation transaction broadcasted to a blockchain and corresponding to an electronic bill that has been accounted is monitored, a created reversed bill corresponding to the electronic bill can be broadcasted to the blockchain for storage. As such, the electronic bill stored in the blockchain can be cancelled.

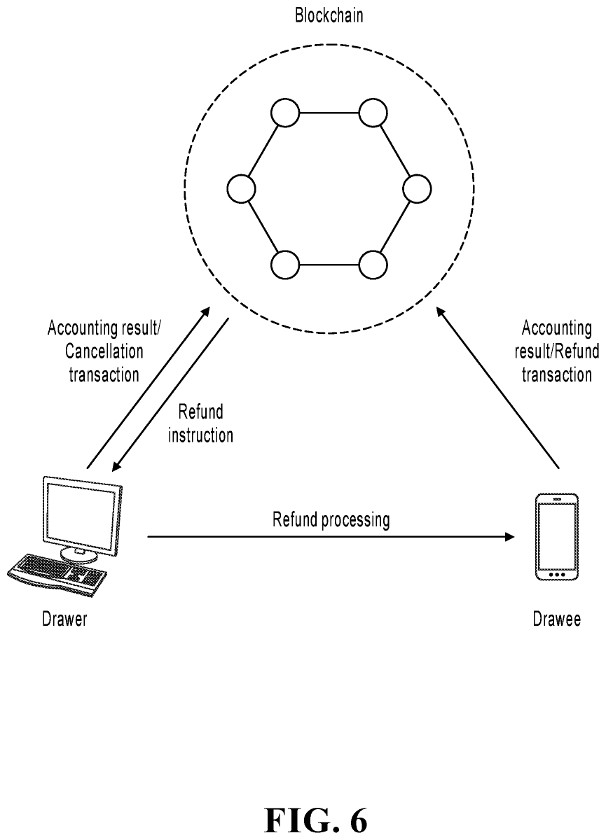

Referring to FIG. 6, FIG. 6 is a schematic diagram illustrating a blockchain-based electronic bill cancellation system, according to an example implementation of the present specification.

In the blockchain-based electronic bill cancellation system shown in FIG. 6, an electronic bill can be stored in the blockchain. For example, for a certain bill, a payee of the bill can, after confirming that payment has been received, issue an electronic bill corresponding to the bill to a payer of the bill, and broadcast the electronic bill to the blockchain for storage. In such case, the payee is a drawer of the electronic bill and the payer is a drawee of the electronic bill.

In addition, after confirming that payment has been received, the drawer can account the bill, that is, account the electronic bill. For example, the payer, the payee, and the amount recorded in the electronic bill are re-recorded in the ledger, so as to facilitate subsequent financial accounting. Subsequently, the drawer can broadcast an accounting result corresponding to the electronic bill to the blockchain for storage. Similarly, the drawee can also account the electronic bill, and broadcast an accounting result corresponding to the electronic bill to the blockchain for storage.

For a certain electronic bill stored in the blockchain, if a drawer of the electronic bill finds that content in the electronic bill is incorrect, for example, an amount recorded in the electronic bill is incorrect, the drawer can directly construct a cancellation transaction corresponding to the electronic bill, and broadcast the cancellation transaction to the blockchain for storage, so as to trigger cancellation processing on the electronic bill stored in the blockchain.

Or when a refund is needed for an order corresponding to the electronic bill, the drawee of the electronic bill can initiate a refund request for the electronic bill to the drawer, so the drawer performs refund processing on the electronic bill, for example, refunds the amount recorded in the electronic bill to the drawee.

The drawee can construct a refund transaction corresponding to the electronic bill, and broadcast the refund transaction to the blockchain for storage, so as to trigger refund processing on the electronic bill in the blockchain.

It is worthwhile to note that each node on the blockchain can maintain a bill state of each electronic bill stored in the blockchain. Because the bill state of the electronic bill can change, and data stored in the blockchain usually cannot be modified, the bill state of each electronic bill maintained by each node on the blockchain is stored locally on the node, and will not be broadcasted to the blockchain for storage.

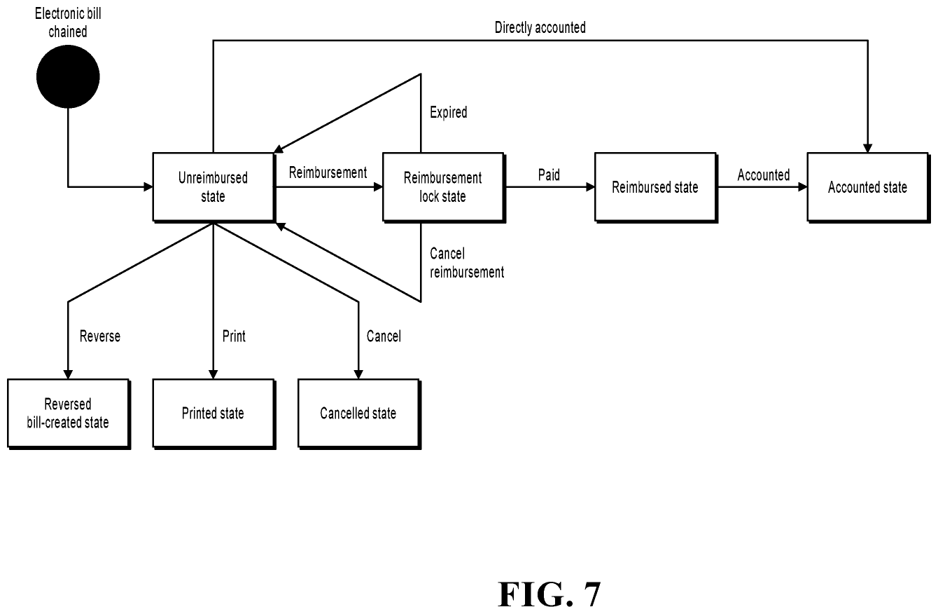

Referring to FIG. 7, FIG. 7 is a schematic diagram illustrating a bill state update procedure of an electronic bill, according to an example implementation of the present specification.

As shown in FIG. 7, after issuing an electronic bill, a bill drawer can broadcast the electronic bill to a blockchain for storage. In such case, the electronic bill is in an unreimbursed state. When a bill-related party (referred to as a reimbursement initiator) such as a bill-using department initiates reimbursement processing on the electronic bill, the electronic bill can be updated from the unreimbursed state to a reimbursement lock state, so as to prevent another bill-using department from performing reimbursement processing on the electronic bill, thereby avoiding repeated reimbursement. When the reimbursement processing for the electronic bill is completed (for example, the amount recorded on the electronic bill is transferred to a specified account of the bill-using department), the electronic bill can be updated from the reimbursement lock state to a reimbursed state. When accounting processing for the electronic bill is completed (for example, the drawer or the drawee re-records the payer, payee, and amount recorded on the electronic bill in the ledger), the electronic bill can be updated from the reimbursed state to an accounted state.

In practice, the electronic bill can be directly accounted without performing reimbursement processing on the electronic bill. In such case, the electronic bill can be updated from the unreimbursed state to the accounted state.

After the electronic bill is updated to the reimbursement lock state, if a reimbursement result corresponding to the electronic bill broadcasted to the blockchain is not monitored within a period of time, the electronic bill can be updated from the reimbursement lock state to the unreimbursed state (that is, the “expiration” process in the figure). Similarly, if reimbursement verification on the electronic bill fails, the electronic bill can be updated from the reimbursement lock state to the unreimbursed state (that is, the “reimbursement cancellation” process in the figure).

In addition to performing reimbursement processing on the electronic bill in the unreimbursed state, the electronic bill can be reversed, printed (for example, printed by using a fiscal blank note), cancelled, etc. In such case, the electronic bill can be correspondingly updated to a reversed bill-created state, a printed state, or a cancelled state.

In practice, the unreimbursed state, the reimbursement lock state, the reimbursed state, and the accounted state can be considered as valid states of electronic bills. The reversed bill-created state, the printed state, and the cancelled stated are considered as invalid states of electronic bills. For an electronic bill in an invalid state, no action can be taken on the electronic bill.

In addition, the bill-related party can send a bill state subscription request to a node on the blockchain. For example, the bill state subscription request can be sent to the node by using a client connected to the node, so as to subscribe to the bill state of the electronic bill maintained by the node.

After the bill-related party subscribes to a bill state of a certain electronic bill maintained by the node on the blockchain, if the bill state of the electronic bill is updated, the node can actively push the updated bill state of the electronic bill to the bill-related party.

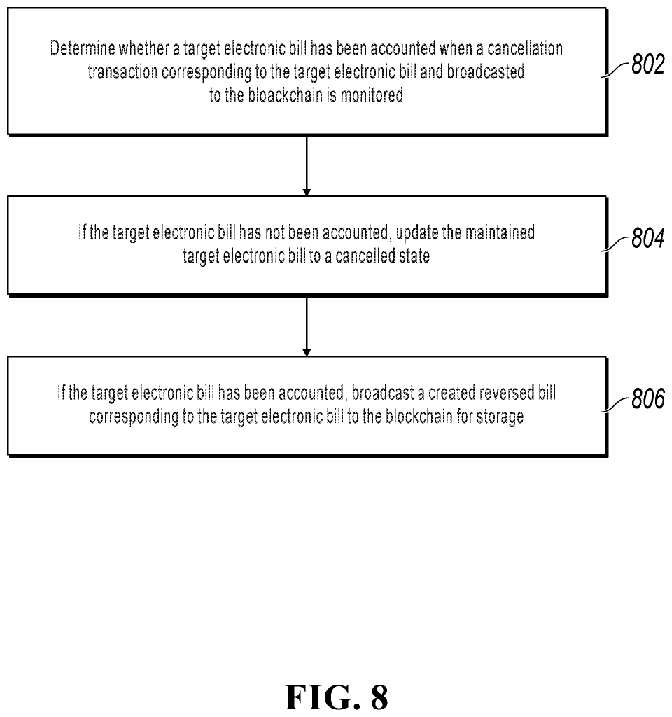

Referring to FIG. 8, FIG. 8 is a flowchart illustrating a blockchain-based electronic bill cancellation method, according to an example implementation of the present specification. The method can be applied to an electronic device added to a blockchain as a node in the blockchain-based electronic bill cancellation system shown in FIG. 6. The electronic device can be a server, a computer, a mobile phone, a tablet device, a notebook computer, a personal digital assistant (PDA), etc. This is not limited in the present specification. The method can include the following steps:

Step 802: Determine whether a target electronic bill has been accounted when a cancellation transaction corresponding to the target electronic bill and broadcasted to the blockchain is monitored.

Step 804: If the target electronic bill has not been accounted, update the maintained target electronic bill to a cancelled state.

Step 806: If the target electronic bill has been accounted, broadcast a created reversed bill corresponding to the target electronic bill to the blockchain for storage.

The following uses an MPT tree data structure to organize account state data in a blockchain into an MPT state tree as an example to describe the technical solutions in the present specification in detail.

It should be emphasized that using the MPT tree data structure to organize the account state data in the blockchain is merely an example.

In practice, for a blockchain project derived from an Ethereum architecture, in addition to an improved Merkle tree such as an MPT tree, a Merkle tree variant, similar to an MPT tree, that incorporates a Trie dictionary tree can also be used. This is not listed in the present specification.

For a certain electronic bill (referred to as a target electronic bill) stored in the blockchain, if a drawer of the target electronic bill needs to cancel the target electronic bill, the drawer can initiate cancellation processing for the target electronic bill, that is, the drawer can construct a cancellation transaction corresponding to the target electronic bill, and broadcast the cancellation transaction to the blockchain for storage. Or if a drawee of the target electronic bill requires a refund of an order corresponding to the target electronic bill, the drawee can initiate refund processing for the target electronic bill, that is, the drawee can construct a refund transaction corresponding to the target electronic bill, and broadcast the refund transaction to the blockchain for storage.

It is worthwhile to note that, the cancellation transaction broadcasted by the drawer to the blockchain and the refund transaction broadcasted by the drawee to the blockchain can be collectively referred to as a cancellation transaction corresponding to the target electronic bill and broadcasted to the blockchain. For a process of broadcasting the cancellation transaction corresponding to the target electronic bill to the blockchain for storage, refer to the previous process of persistently storing real data generated in the physical world in the blockchain. Details are omitted here.

The node on the blockchain can monitor data stored in the blockchain, so the cancellation transaction corresponding to the target electronic bill and broadcasted to the blockchain can be monitored. When monitoring the cancellation transaction, the node on the blockchain can first determine whether the target electronic bill has been accounted.

In practice, for a certain electronic bill stored in the blockchain, after accounting the electronic bill, a drawer or a drawee of the electronic bill can broadcast an accounting result corresponding to the electronic bill to the blockchain for storage. For a process of broadcasting the accounting result to the blockchain for storage, refer to the previous process of persistently storing real data generated in the physical world in the blockchain. Details are omitted here.

In a described implementation, because the node on the blockchain can monitor the data stored in the blockchain, the node on the blockchain can determine whether the previous accounting result is monitored. If the node on the blockchain monitors the accounting result, it can be considered that the electronic bill has been accounted, so the maintained electronic bill can be updated to an accounted state.

It is worthwhile to note that, because each node on the blockchain can determine whether the accounting result is monitored, each node on the blockchain can update the maintained electronic bill to the accounted state when monitoring the accounting result.

In practice, for a certain electronic bill stored in the blockchain, the node on the blockchain can maintain a bill state of the electronic bill by maintaining a correspondence between an identifier of the electronic bill (for example, an electronic bill number) and a state.

In such case, data in the accounting result can include the identifier of the electronic bill. When the node on the blockchain monitors the accounting result, the node can update, based on the identifier of the electronic bill in the accounting result, the bill state corresponding to the identifier of the electronic bill in the correspondence between the identifier of the maintained electronic bill and the state to the accounted state.

In addition, when monitoring the cancellation transaction, the node on the blockchain can determine, by determining whether the maintained target electronic bill is in the accounted state, whether the target electronic bill has been accounted.

Data in the cancellation transaction can include the identifier of the target electronic bill. When the node on the blockchain monitors the cancellation transaction, based on the identifier of the target electronic bill in the cancellation transaction, the node can search for, as the bill state of the target electronic bill, the bill state corresponding to the identifier of the target electronic bill in the maintained correspondence between the identifier of the electronic bill and the state.

If it is determined that the bill state of the target electronic bill is in the accounted state, that is, the maintained target electronic bill is in the accounted state, it is determined that the target electronic bill has been accounted.

Correspondingly, if the bill state of the target electronic bill is not in the accounted state, that is, the maintained target electronic bill is not in the accounted state, it is determined that the target electronic bill has not been accounted.

For example, a bill state of each electronic bill stored in the blockchain and maintained by each node on the blockchain can be shown in Table 1 below:

TABLE 1

| Electronic bill | State |
|---|---|
| Electronic bill 1 | Accounted |
| Electronic bill 2 | Cancelled |
| Electronic bill 3 | Unreimbursed |
| . . . | . . . |

In the present specification, all states except the accounted state, the cancelled state, and the reversed bill-created state can be considered as unaccounted states.

As shown in Table 1, when monitoring cancellation transaction 1 corresponding to electronic bill 1, the node on the blockchain can determine that electronic bill 1 is in the accounted state, that is, electronic bill 1 has been accounted. When monitoring cancellation transaction 2 corresponding to electronic bill 2, the node on the blockchain can determine that electronic bill 2 is in the cancelled state, that is, electronic bill 2 is not in the accounted state, so it can be determined that electronic bill 2 has not been accounted. When monitoring cancellation transaction 3 corresponding to electronic bill 3, the node on the blockchain can determine that electronic bill 3 is in the unreimbursed state, that is, electronic bill 3 is not in the accounted state, so it can be determined that electronic bill 3 has not been accounted.

In another implementation, when monitoring the cancellation transaction, the node on the blockchain can determine, by determining whether the blockchain has stored an accounting result corresponding to the target electronic bill, whether the target electronic bill has been accounted.

Data in the accounting result can include an identifier of the electronic bill corresponding to the accounting result. Data in the cancellation transaction can include the identifier of the target electronic bill. When monitoring the cancellation transaction, the node on the blockchain can determine, based on the identifier of the target electronic bill in the cancellation transaction, whether the blockchain stores an accounting result in which an electronic bill identifier is the identifier of the target electronic bill.

If it is determined that the blockchain stores an accounting result in which an electronic bill identifier is the identifier of the target electronic bill, it can be determined that the target electronic bill has been accounted.

Correspondingly, if it is determined that the blockchain does not store an accounting result in which an electronic bill identifier is the identifier of the target electronic bill, it can be determined that the target electronic bill has not been accounted.

Further, if the node on the blockchain determines that the target electronic bill has not been accounted, the maintained target electronic bill can be directly updated to the cancelled state, so as to perform cancellation processing on the target electronic bill. Subsequently, because the target electronic bill is already in the cancelled state, any operation cannot be performed on the target electronic bill, for example, accounting processing on the target electronic bill can be terminated.

If the node on the blockchain determines that the target electronic bill has been accounted, a reversed bill corresponding to the target electronic bill can be created, and the reversed bill is broadcasted to the blockchain for storage, so as to perform cancellation processing on the target electronic bill. It is worthwhile to note that in such case, because the target electronic bill has been accounted, the reversed bill needs to be accounted to ensure break-even. A process of performing accounting processing on the reversed bill is the same as the process of performing accounting processing on the target electronic bill, and details are omitted in the present specification.

In practice, for a certain electronic bill, data such as a payee and a payer in the electronic bill can be the same as that of the reversed bill corresponding to the electronic bill, but a sum of an amount in the reversed bill and an amount in the electronic bill should be 0. That is, the amount in the reversed bill is an inverse number of the amount in the electronic bill.

For example, assume that a payee in a certain electronic bill is payee A, a payer is payer B, and an amount is RMB 100. In such case, a payee in a reversed bill corresponding to the electronic bill is also payee A, a payer is also payer B, but an amount is RMB−100 (i.e., −100+100=0).

In an implementation, when determining that the target electronic bill has been accounted, the node on the blockchain can locally create, based on a predetermined bill creation logic, a reversed bill corresponding to the target electronic bill. For example, the target electronic bill can be copied, and an amount in the copied electronic bill is modified to a number inverse to an amount in the target electronic bill. The modified electronic bill can be used as the reversed bill of the target electronic bill. The bill creation logic can be predetermined by a person skilled in the art and stored in the node.

After the node locally creates the reversed bill corresponding to the target electronic bill, the node can broadcast the reversed bill to the blockchain for storage. For a process of broadcasting the reversed bill to the blockchain for storage, refer to the previous process of persistently storing real data generated in the physical world in the blockchain. Details are omitted here.

In another implementation, when determining that the target electronic bill has been accounted, the node on the blockchain can invoke a bill creation logic specified in a smart contract deployed on the blockchain to create a reversed bill corresponding to the target electronic bill, that is, directly create the reversed bill corresponding to the target electronic bill in the blockchain.

The bill creation logic can be program codes (for example, some program methods or functions that can be invoked) specified in the smart contract and related to the execution logic for creating the reversed bill corresponding to the electronic bill. For a procedure for creating and invoking the smart contract, refer to the previous procedure for creating and invoking the smart contract. Details are omitted here.

It is worthwhile to note that, after broadcasting the reversed bill to the blockchain for storage, the node on the blockchain can update the maintained target electronic bill to a reversed bill-created state, so as to avoid a subsequent misoperation on the electronic bill.

It can be seen from the previous description of the cancellation transaction corresponding to the target electronic bill that the cancellation transaction can be a cancellation transaction corresponding to the target electronic bill and broadcasted by a drawer of the target electronic bill to the blockchain. Or the cancellation transaction can be a refund transaction corresponding to the target electronic bill and broadcasted by the drawee of the target electronic bill to the blockchain.

The following separately describes the following two cases in which the drawer initiates cancellation processing for the target electronic bill, and the drawee initiates refund processing for the target electronic bill.

When the drawer initiates cancellation processing for the target electronic bill, that is, the drawer constructs a cancellation transaction corresponding to the target electronic bill, and broadcasts the cancellation transaction to the blockchain for storage, the node on the blockchain can receive the cancellation transaction and perform consensus processing on the received cancellation transaction. After a consensus is reached, the node on the blockchain can seal the cancellation transaction into a block, and persistently stores the reimbursement transaction in the blockchain.

For the cancellation transaction sealed into the block, the node on the blockchain can execute the cancellation transaction, that is, invoke, in response to the cancellation transaction, a cancellation verification logic specified in a smart contract deployed on the blockchain to perform cancellation verification on the target electronic bill, that is, determine whether the target electronic bill satisfies the cancellation criteria.

The cancellation verification logic can be program codes (for example, some program methods or functions that can be invoked) specified in the smart contract and related to the execution logic for performing cancellation verification on the electronic bill. For a procedure for creating and invoking the smart contract, refer to the previous procedure for creating and invoking the smart contract. Details are omitted here.

If the target electronic bill satisfies the cancellation criteria, that is, cancellation verification on the target electronic bill succeeds, the smart contract can generate a verification success event corresponding to the target electronic bill. When monitoring the verification success event, the node can further determine whether the target electronic bill has been accounted. As such, when the target electronic bill has not been accounted, the node can update the maintained target electronic bill to a cancelled state, or when the target electronic bill has been accounted, the node broadcasts a created reversed bill corresponding to the target electronic bill to the blockchain for storage.

In practice, after generating the verification success event, the smart contract can store the verification success event in a transaction log corresponding to the cancellation transaction. The node can perform log monitoring, so the verification success event stored in the transaction log corresponding to the cancellation transaction can be monitored. When monitoring the verification success event, the node can further determine whether the target electronic bill has been accounted.

In an implementation, cancellation criteria for the electronic bill can include cancellation permission criteria and cancellation period criteria.

The cancellation permission criteria for the target electronic bill can be that the drawer (that is, a user initiating cancellation processing for the target electronic bill) has the cancellation permission for the target electronic bill, for example, whether the drawer is a payee recorded in the target electronic bill.

For example, the data in the cancellation transaction can include a user identifier (for example, a taxpayer registration number) of the drawer. The node on the blockchain can first determine a user identifier of a payee recorded in the target electronic bill, and then compare whether the two user identifiers are consistent. If the two user identifiers are consistent, the node on the blockchain can determine that the drawer is the payee recorded in the target electronic bill, and can determine that the target electronic bill satisfies the cancellation permission criteria.

The cancellation period criteria for the target electronic bill can be that a time interval between an issuing moment recorded in the target electronic bill and the time point at which the cancellation transaction is monitored is less than a time interval within which cancellation is allowed. The time interval within which cancellation is allowed can be predetermined by a bill manager.

For example, the node on the blockchain can locally maintain a predetermined time interval within which cancellation is allowed, assume that the time interval within which cancellation is allowed is 48 hours. In such case, the node on the blockchain can determine whether a time interval between the issuing moment recorded in the target electronic bill and the time point at which the cancellation transaction is monitored is less than the time interval within which cancellation is allowed. Assume that the issuing moment recorded in the target electronic bill is 15:00 on May 31st, a moment at which the node on the blockchain monitors the cancellation transaction is 20:00 on June 1st, and a time interval between the two is 29 hours and is less than the time interval within which cancellation is allowed. Therefore, the node on the blockchain can determine that the target electronic bill satisfies the cancellation period criteria.

When the drawee initiates refund processing for the target electronic bill, that is, the drawee constructs a refund transaction corresponding to the target electronic bill and broadcasts the refund transaction to the blockchain for storage, the node on the blockchain can receive the refund transaction and perform consensus processing on the received refund transaction. After a consensus is reached, the node on the blockchain can seal the refund transaction into a block, and persistently stores the refund transaction in the blockchain.

For the refund transaction sealed into the block, the node on the blockchain can execute the refund transaction, that is, invoke, in response to the refund transaction, a refund verification logic specified in a smart contract deployed on the blockchain, to perform refund verification on the target electronic bill, that is, determine whether the target electronic bill satisfies the refund criteria.

The refund verification logic can be program codes (for example, some program methods or functions that can be invoked) specified in the smart contract and related to the execution logic for performing refund verification on the electronic bill. For a procedure for creating and invoking the smart contract, refer to the previous procedure for creating and invoking the smart contract. Details are omitted here.

If the target electronic bill satisfies the refund criteria, that is, refund verification on the target electronic bill succeeds, the smart contract can generate a verification success event corresponding to the target electronic bill. When monitoring the verification success event, the node can further determine whether the target electronic bill has been accounted. As such, when the target electronic bill has not been accounted, the node can update the maintained target electronic bill to a cancelled state, or when the target electronic bill has been accounted, the node broadcasts a created reversed bill corresponding to the target electronic bill to the blockchain for storage.

In practice, after generating the verification success event, the smart contract can store the verification success event in a transaction log corresponding to the refund transaction. The node can perform log monitoring, so the verification success event stored in the transaction log corresponding to the refund transaction can be monitored. When monitoring the verification success event, the node can further determine whether the target electronic bill has been accounted.

In an implementation, refund criteria for the electronic bill can include refund permission criteria and refund period criteria.

The refund permission criteria for the target electronic bill can be that the drawee (that is, a user initiating refund processing for the target electronic bill) has a refund permission for the target electronic bill, for example, whether the drawee is a payer recorded in the target electronic bill.

For example, the data in the refund transaction can include a user identifier (for example, a taxpayer registration number) of the drawee. The node on the blockchain can first determine a user identifier of a payer recorded in the target electronic bill, and then compare whether the two user identifiers are consistent. If the two user identifiers are consistent, the node on the blockchain can determine that the drawee is the payer recorded in the target electronic bill, and can determine that the target electronic bill satisfies the refund permission criteria.

The refund amount criteria for the target electronic bill can be that the refund amount requested by the drawee is less than the amount recorded in the target electronic bill.

For example, data in the refund transaction can include the refund amount requested by the drawee. The node in the blockchain can first determine the amount recorded in the target electronic bill, and then determine whether the refund amount requested by the drawee is less than the amount recorded in the target electronic bill. If the refund amount requested by the drawee is less than the amount recorded in the target electronic bill, the node on the blockchain can determine that the target electronic bill satisfies the refund amount criteria.

The refund period criteria for the target electronic bill can be that a time interval between an issuing moment recorded in the target electronic bill and the time point at which the refund transaction is monitored is less than a time interval within which refund is allowed. The time interval within which refund is allowed can be predetermined by a bill manager.

For example, the node on the blockchain can locally maintain a predetermined time interval within which refund is allowed, assume that the time interval within which refund is allowed is 48 hours. In such case, the node on the blockchain can determine whether a time interval between the issuing moment recorded in the target electronic bill and the time point at which the refund transaction is monitored is less than the time interval within which refund is allowed. Assume that the issuing moment recorded in the target electronic bill is 15:00 on May 31st, a moment at which the node on the blockchain monitors the refund transaction is 20:00 on June 1st, and a time interval between the two is 29 hours and is less than the time interval within which refund is allowed. Therefore, the node on the blockchain can determine that the target electronic bill satisfies the refund period criteria.

In addition, after broadcasting the created reversed bill corresponding to the target electronic bill to the blockchain for storage, the node on the blockchain can instruct the drawer of the target electronic bill to perform refund processing on the target electronic bill.

In an implementation, after broadcasting the reversed bill to the blockchain for storage, the node on the blockchain can further update the maintained target electronic bill to a reversed bill-created state. The drawer can subscribe to a bill state of the target electronic bill maintained by the node on the blockchain.

In such case, after updating the maintained target electronic bill to the reversed bill-created state, the node can push the reversed bill-created state of the target electronic bill to the drawer who has subscribed to the bill state of the target electronic bill, so as to trigger the drawer to perform refund processing on the target electronic bill in the reversed bill-created state. That is, the drawer can perform refund processing on the target electronic bill after receiving the reversed bill-created state of the target electronic bill pushed by the node. For example, the drawer can receive, by using a client connected to the node, the reversed bill-created state of the target electronic bill pushed by the node, and perform refund processing on the target electronic bill by using the client.

Or, after updating the target electronic bill to the reversed bill-created state, the node can directly send, to the drawer, a notification message used to instruct to perform refund processing on the target electronic bill, so as to instruct the drawer to perform refund processing on the target electronic bill. That is, after receiving the notification message sent by the node, the drawer can perform refund processing on the target electronic bill.

In the previous technical solution, on one hand, when a cancellation transaction broadcasted to a blockchain and corresponding to an electronic bill that has not been accounted is monitored, the maintained electronic bill can be updated to a cancelled state. On the other hand, when a cancellation transaction broadcasted to a blockchain and corresponding to an electronic bill that has been accounted is monitored, a created reversed bill corresponding to the electronic bill can be broadcasted to the blockchain for storage. As such, the electronic bill stored in the blockchain can be cancelled.

Corresponding to the previous implementation of the blockchain-based electronic bill cancellation method, the present specification further provides an implementation of a blockchain-based electronic bill cancellation apparatus.

The implementation of the blockchain-based electronic bill cancellation apparatus in the present specification can be applied to an electronic device. The apparatus implementation can be implemented by software, hardware, or a combination of hardware and software. Software implementation is used as an example. As a logical device, the device is formed by reading a corresponding computer program instruction in a non-volatile memory to a memory by a processor of an electronic device where the device is located.

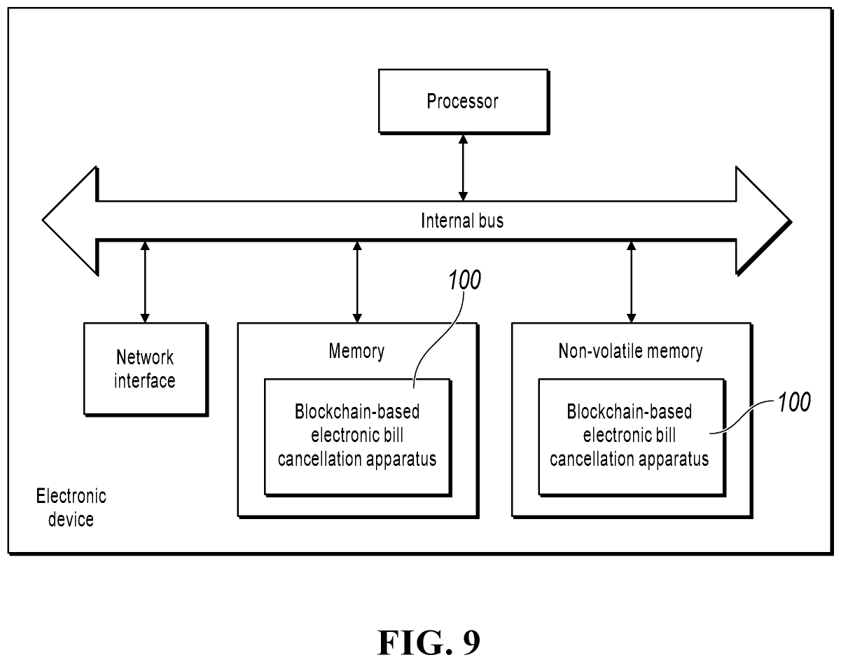

In terms of hardware, referring to FIG. 9, FIG. 9 is a hardware structural diagram illustrating an electronic device where the blockchain-based electronic bill cancellation apparatus is located in the present specification. In addition to a processor, a memory, a network interface, and anon-volatile memory shown in FIG. 9, the electronic device where the apparatus is located in the implementation can usually include other hardware based on an actual function of blockchain-based electronic bill cancellation. Details are omitted.

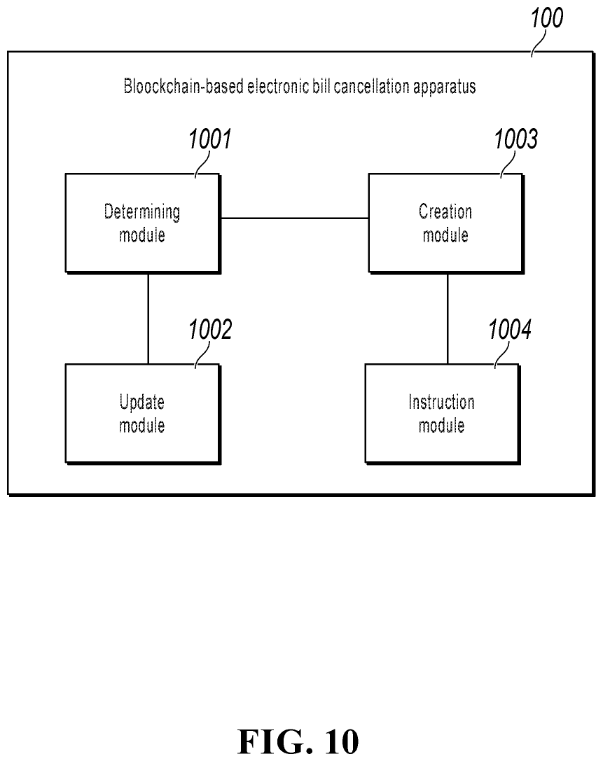

Referring to FIG. 10, FIG. 10 is a block diagram illustrating a blockchain-based electronic bill cancellation apparatus, according to an example implementation of the present specification. The apparatus 100 can be applied to the electronic device shown in FIG. 9, and the electronic device can be added to the blockchain as anode. The blockchain stores electronic bills. The apparatus 100 can include: a determining module 1001, configured to determine whether a target electronic bill has been accounted when a cancellation transaction corresponding to the target electronic bill and broadcasted to the blockchain is monitored; an update module 1002, configured to: if the target electronic bill has not been accounted, update the maintained target electronic bill to a cancelled state; and a creation module 1003, configured to: if the target electronic bill has been accounted, broadcast a created reversed bill corresponding to the target electronic bill to the blockchain for storage.

In the implementation, the determining module 1001 can be configured to: determine whether the maintained target electronic bill is in an accounted state; if the target electronic bill is in the accounted state, determine that the target electronic bill has been accounted; or if the target electronic bill is not in the accounted state, determine that the target electronic bill has not been accounted.

In the implementation, the creation module 1003 can be configured to: invoke a bill creation logic specified in a smart contract deployed on the blockchain, to create the reversed bill corresponding to the target electronic bill.

In this implementation, the cancellation transaction corresponding to the target electronic bill and broadcasted to the blockchain is a refund transaction corresponding to the target electronic bill and broadcasted by a drawee of the target electronic bill to the blockchain; and the apparatus 100 can further include: an instruction module 1004, configured to instruct a drawer of the target electronic bill to perform refund processing on the target electronic bill, after the created reversed bill corresponding to the target electronic bill is broadcasted to the blockchain for storage.

In this implementation, the drawer of the target electronic bill subscribes to a bill state of the target electronic bill maintained by the node; and the instruction module 1004 can be configured to: after the created reversed bill corresponding to the target electronic bill is broadcasted to the blockchain for storage, update the maintained target electronic bill to a reversed bill-created state, and push the reversed bill-created state of the target electronic bill to the drawer, so as to trigger the drawer to perform refund processing on the target electronic bill.

In the implementation, the determining module 1001 can be configured to: invoke, in response to the refund transaction, a refund verification logic specified in a smart contract deployed on the blockchain to determine whether the target electronic bill satisfies refund criteria; and determine, in response to a monitored verification success event generated by the smart contract and corresponding to the target electronic bill, whether the target electronic bill has been accounted.

In this implementation, the refund criteria can include refund permission criteria, refund amount criteria, and refund period criteria.

In this implementation, the cancellation transaction corresponding to the target electronic bill and broadcasted to the blockchain is a cancellation transaction corresponding to the target electronic bill and broadcasted by a drawer of the target electronic bill to the blockchain; and the determining module 1001 can be configured to: invoke, in response to the cancellation transaction, a cancellation verification logic specified in a smart contract deployed on the blockchain to determine whether the target electronic bill satisfies cancellation criteria; and determine, in response to a monitored verification success event generated by the smart contract and corresponding to the target electronic bill, whether the target electronic bill has been accounted.

In this implementation, the cancellation criteria can include cancellation permission criteria and cancellation period criteria.

For an implementation process of functions and roles of each module in the apparatus, reference can be made to an implementation process of a corresponding step in the previous method. Details are omitted here.

Because an apparatus implementation corresponds to a method implementation, for related parts, references can be made to related descriptions in the method implementation. The previously described apparatus implementation is merely an example. The modules described as separate parts may or may not be physically separate, and parts displayed as modules may or may not be physical modules, may be located in one position, or may be distributed on a plurality of network modules. Some or all of the modules can be selected based on actual requirements to achieve the objectives of the solutions of the present specification. A person of ordinary skill in the art can understand and implement the implementations of the present application without creative efforts.

The system, apparatus, module, or unit illustrated in the previous implementations can be implemented by using a computer chip or an entity, or can be implemented by using a product having a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

In a typical configuration, the computer includes one or more processors (CPU), input/output interfaces, network interfaces, and memories.

The memory can include a non-persistent memory, a random access memory (RAM), and/or a non-volatile memory in a computer readable medium, for example, a read-only memory (ROM) or a flash memory (flash RAM). The memory is an example of the computer readable medium.

The computer readable medium includes persistent, non-persistent, movable, and unmovable media that can store information by using any method or technology. The information can be a computer readable instruction, a data structure, a program module, or other data. Examples of a computer storage medium include but are not limited to a phase change random access memory (PRAM), a static RAM (SRAM), a dynamic RAM (DRAM), a RAM of another type, a read-only memory (ROM), an electrically erasable programmable ROM (EEPROM), a flash memory or another memory technology, a compact disc ROM (CD-ROM), a digital versatile disc (DVD) or another optical storage, a cassette tape, a magnetic disk storage, a quantum memory, a storage medium based on grapheme, another magnetic storage device, or any other non-transmission medium. The computer storage medium can be used to store information that can be accessed by the computing device. As described in the present application, the computer readable medium does not include computer readable transitory media such as a modulated data signal and a carrier.

It is worthwhile to further note that, the terms “include”, “contain”, or their any other variants are intended to cover a non-exclusive inclusion, so a process, a method, a product or a device that includes a list of elements not only includes those elements but also includes other elements which are not expressly listed, or further includes elements inherent to such process, method, product or device. Without more constraints, an element preceded by “includes a . . . ” does not preclude the existence of additional identical elements in the process, method, product or device that includes the element.

Specific implementations of the present specification are described above. Other implementations fall within the scope of the appended claims. In some situations, the actions or steps described in the claims can be performed in an order different from the order in the implementations and the desired results can still be achieved. In addition, the process depicted in the accompanying drawings does not necessarily need a particular execution order to achieve the desired results. In some implementations, multi-tasking and concurrent processing is feasible or can be advantageous.

Terms used in one or more implementations of the present specification are merely used to describe specific implementations, and are not intended to limit the one or more implementations of the present specification. The terms “a” and “the” of singular forms used in one or more implementations of the present specification and the appended claims are also intended to include plural forms, unless otherwise specified in the context clearly. It should be further understood that the term “and/or” used in the present specification indicates and includes any or all possible combinations of one or more associated listed items.

It should be understood that although terms “first”, “second”, “third”, etc. can be used in one or more implementations of the present specification to describe various types of information, the information is not limited to these terms. These terms are only used to differentiate between information of the same type. For example, without departing from the scope of one or more implementations of the present specification, first information can also be referred to as second information, and similarly, the second information can be referred to as the first information. Depending on the context, for example, the word “if” used here can be explained as “while”, “when”, or “in response to determining”.

The previous descriptions are only example implementations of one or more implementations of the present specification, but are not intended to limit the one or more implementations of the present specification. Any modification, equivalent replacement, improvement, etc. made without departing from the spirit and principle of the one or more implementations of the present specification shall fall within the protection scope of the one or more implementations of the present specification.

What is claimed is:

1. A computer-implemented method for blockchain-based electronic bill cancellation, comprising:
in response to detecting a cancellation transaction broadcasted to a blockchain that stores electronic bills, the cancellation transaction corresponding to a target electronic bill, determining whether the target electronic bill has been accounted by a blockchain node;
in response to determining that the target electronic bill has been accounted:
creating a reversed bill corresponding to the target electronic bill; and
broadcasting the reversed bill corresponding to the target electronic bill to the blockchain for storage;
in response to detecting a second cancellation transaction broadcasted to the blockchain, the cancellation transaction corresponding to a second target electronic bill, determining whether the second target electronic bill has been accounted by the blockchain node; and
in response to determining that the second target electronic bill has not been accounted, updating the second target electronic bill to a cancelled state.

2. The computer-implemented method according to claim 1, wherein determining whether a target electronic bill has been accounted comprises:
determining whether the target electronic bill is in an accounted state;
if the target electronic bill is in the accounted state, determining that the target electronic bill has been accounted; or
if the target electronic bill is not in the accounted state, determining that the target electronic bill has not been accounted.

3. The computer-implemented method according to claim 1, wherein broadcasting the reversed bill corresponding to the target electronic bill to the blockchain for storage comprises:
invoking a bill creation logic specified in a smart contract deployed on the blockchain in creating the reversed bill corresponding to the target electronic bill.

4. The computer-implemented method according to claim 1, wherein:
the cancellation transaction corresponding to the target electronic bill comprises a refund transaction corresponding to the target electronic bill and the cancellation transaction broadcasted to the blockchain comprises the cancellation transaction broadcasted by a drawee of the target electronic bill to the blockchain; and
further comprising instructing a drawer of the target electronic bill to perform refund processing on the target electronic bill after the reversed bill corresponding to the target electronic bill is broadcasted to the blockchain for storage.

5. The computer-implemented method according to claim 4, wherein the drawer of the target electronic bill subscribes to a bill state of the target electronic bill maintained by the blockchain node; and
wherein instructing a drawer of the target electronic bill to perform refund processing on the target electronic bill after the reversed bill corresponding to the target electronic bill is broadcasted to the blockchain for storage comprises:
after the reversed bill corresponding to the target electronic bill is broadcasted to the blockchain for storage, updating the target electronic bill to a reversed bill-created state, and pushing the reversed bill-created state of the target electronic bill to the drawer to trigger the drawer to perform refund processing on the target electronic bill.

6. The computer-implemented method according to claim 4, wherein in response to detecting a cancellation transaction broadcasted to a blockchain that stores electronic bills, the cancellation transaction corresponding to a target electronic bill, determining whether the target electronic bill has been accounted comprises:
in response to the refund transaction, invoking a refund verification logic specified in a smart contract deployed on the blockchain to determine whether the target electronic bill satisfies refund criteria; and
in response to a monitored verification success event generated by the smart contract and corresponding to the target electronic bill, determining whether the target electronic bill has been accounted.

7. The computer-implemented method according to claim 6, wherein the refund criteria comprise refund permission criteria, refund amount criteria, and refund period criteria.

8. The computer-implemented method according to claim 1, wherein the cancellation transaction broadcasted to the blockchain comprises a cancellation transaction broadcasted by a drawer of the target electronic bill to the blockchain; and
in response to detecting a cancellation transaction broadcasted to a blockchain that stores electronic bills, the cancellation transaction corresponding to a target electronic bill, determining whether the target electronic bill has been accounted comprises:
in response to the cancellation transaction, invoking a cancellation verification logic specified in a smart contract deployed on the blockchain to determine whether the target electronic bill satisfies cancellation criteria; and
in response to a monitored verification success event generated by the smart contract and corresponding to the target electronic bill, determining whether the target electronic bill has been accounted.

9. The computer-implemented method according to claim 8, wherein the cancellation criteria comprise cancellation permission criteria and cancellation period criteria.

10. A computer-implemented system for blockchain-based electronic bill cancellation, comprising:
one or more computers; and
one or more computer memory devices interoperably coupled with the one or more computers and having tangible, non-transitory, machine-readable media storing one or more instructions that, when executed by the one or more computers, perform one or more operations comprising:
in response to detecting a cancellation transaction broadcasted to a blockchain that stores electronic bills, the cancellation transaction corresponding to a target electronic bill, determining whether the target electronic bill has been accounted by a blockchain node;
in response to determining that the target electronic bill has been accounted:
creating a reversed bill corresponding to the target electronic bill; and
broadcasting the reversed bill corresponding to the target electronic bill to the blockchain for storage;
in response to detecting a second cancellation transaction broadcasted to the blockchain, the cancellation transaction corresponding to a second target electronic bill, determining whether the second target electronic bill has been accounted by the blockchain node; and
in response to determining that the second target electronic bill has not been accounted, updating the second target electronic bill to a cancelled state.

11. The computer-implemented system according to claim 10, wherein determining whether a target electronic bill has been accounted comprises:
determining whether the target electronic bill is in an accounted state;
if the target electronic bill is in the accounted state, determining that the target electronic bill has been accounted; or
if the target electronic bill is not in the accounted state, determining that the target electronic bill has not been accounted.

12. The computer-implemented system according to claim 10, wherein broadcasting the reversed bill corresponding to the target electronic bill to the blockchain for storage comprises invoking a bill creation logic specified in a smart contract deployed on the blockchain in creating the reversed bill corresponding to the target electronic bill.

13. The computer-implemented system according to claim 10, wherein:
the cancellation transaction corresponding to the target electronic bill comprises a refund transaction corresponding to the target electronic bill and the cancellation transaction broadcasted to the blockchain comprises the cancellation transaction broadcasted by a drawee of the target electronic bill to the blockchain; and
the operations further comprise instructing a drawer of the target electronic bill to perform refund processing on the target electronic bill after the reversed bill corresponding to the target electronic bill is broadcasted to the blockchain for storage.

14. The computer-implemented system according to claim 13, wherein the drawer of the target electronic bill subscribes to a bill state of the target electronic bill maintained by the blockchain node; and
wherein instructing a drawer of the target electronic bill to perform refund processing on the target electronic bill after the reversed bill corresponding to the target electronic bill is broadcasted to the blockchain for storage comprises:
after the reversed bill corresponding to the target electronic bill is broadcasted to the blockchain for storage, updating the target electronic bill to a reversed bill-created state, and pushing the reversed bill-created state of the target electronic bill to the drawer to trigger the drawer to perform refund processing on the target electronic bill.

15. The computer-implemented system according to claim 13, wherein in response to detecting a cancellation transaction broadcasted to a blockchain that stores electronic bills, the cancellation transaction corresponding to a target electronic bill, determining whether the target electronic bill has been accounted comprises:
in response to the refund transaction, invoking a refund verification logic specified in a smart contract deployed on the blockchain to determine whether the target electronic bill satisfies refund criteria; and
in response to a monitored verification success event generated by the smart contract and corresponding to the target electronic bill, determining whether the target electronic bill has been accounted.

16. The computer-implemented system according to claim 10, wherein the cancellation transaction broadcasted to the blockchain comprises a cancellation transaction broadcasted by a drawer of the target electronic bill to the blockchain; and
in response to detecting a cancellation transaction broadcasted to a blockchain that stores electronic bills, the cancellation transaction corresponding to a target electronic bill, determining whether the target electronic bill has been accounted comprises:
in response to the cancellation transaction, invoking a cancellation verification logic specified in a smart contract deployed on the blockchain to determine whether the target electronic bill satisfies cancellation criteria; and
in response to a monitored verification success event generated by the smart contract and corresponding to the target electronic bill, determining whether the target electronic bill has been accounted.

17. A non-transitory, computer-readable medium storing one or more instructions executable by a computer system to perform operations for blockchain-based electronic bill cancellation, comprising:
in response to detecting a cancellation transaction broadcasted to a blockchain that stores electronic bills, the cancellation transaction corresponding to a target electronic bill, determining whether the target electronic bill has been accounted by a blockchain node;
in response to determining that the target electronic bill has been accounted:
creating a reversed bill corresponding to the target electronic bill; and
broadcasting the reversed bill corresponding to the target electronic bill to the blockchain for storage;
in response to detecting a second cancellation transaction broadcasted to the blockchain, the cancellation transaction corresponding to a second target electronic bill, determining whether the second target electronic bill has been accounted by the blockchain node; and
in response to determining that the second target electronic bill has not been accounted, updating the second target electronic bill to a cancelled state.

18. The non-transitory, computer-readable medium according to claim 17, wherein determining whether a target electronic bill has been accounted comprises:
determining whether the target electronic bill is in an accounted state;
if the target electronic bill is in the accounted state, determining that the target electronic bill has been accounted; or
if the target electronic bill is not in the accounted state, determining that the target electronic bill has not been accounted.

19. The non-transitory, computer-readable medium according to claim 17, wherein broadcasting the reversed bill corresponding to the target electronic bill to the blockchain for storage comprises invoking a bill creation logic specified in a smart contract deployed on the blockchain in creating the reversed bill corresponding to the target electronic bill.

20. The non-transitory, computer-readable medium according to claim 17, wherein:
the cancellation transaction corresponding to the target electronic bill comprises a refund transaction corresponding to the target electronic bill and the cancellation transaction broadcasted to the blockchain comprises the cancellation transaction broadcasted by a drawee of the target electronic bill to the blockchain; and
the operations further comprise instructing a drawer of the target electronic bill to perform refund processing on the target electronic bill after the reversed bill corresponding to the target electronic bill is broadcasted to the blockchain for storage.
